(19) United States
(12) Patent Application Publication
(10) Pub. No.: US 2021/0402875 A1
(43) Pub. Date: Dec. 30, 2021

(54) Automobile with Extended 90-Degree Steering Range for Parallel Parking or Other Uses

(71) Applicant: Xuan Chieu Pham, Winnipeg (CA)

(72) Inventor: Xuan Chieu Pham, Winnipeg (CA)

(21) Appl. No.: 16/911,529

(22) Filed: Jun. 25, 2020

(51) Int. Cl. B60K 17/30; B62D 7/18; B60G 7/00; B60K 17/22; B62D 7/14; B62D 7/15; B62D 7/20

(52) U.S. Cl. CPC B60K 17/30; B62D 7/18; B60G 7/001; B60K 17/22; B62D 1/04; B62D 7/1509; B62D 7/20; B60G 2206/50; B60G 2206/124; B62D 7/14

(57) ABSTRACT

An automobile having sets of front and rear wheels, of which one or both sets are steerable wheels and one or both sets are driven wheels. Each steerable wheel is rotatably supported on a respective steering knuckle that is swivelable about an upright steering axis, and is coupled to the frame by a suspension system for relative movement upwardly and downwardly of the automobile's frame. The steering knuckle of each steerable wheel is movable through a ninety degree range between a straight-ahead position for longitudinally straight travel of the automobile in a normal road travel mode, and a ninety-degree position for lateral travel of the automobile in another mode.

### FIELD OF THE INVENTION

The present invention relates generally to automobiles, and more specifically to steering systems thereof.

### BACKGROUND

Many drivers find parallel parking to be a challenging exercise, especially when the available space between two parked automobiles is particularly tight relative to the size of the driver's automobile. Furthermore, there are situations where the available space between two previously parked automobiles exceeds the length of the driver's automobile, but not by a sufficient amount capable of admitting the driver's automobiles using conventional parallel parking techniques.

Accordingly, it would be desirable to provide an automobile capable of manoeuvring laterally into an available parallel parking space.

### SUMMARY OF THE INVENTION

According to one aspect of the invention, there is provided an automobile comprising:

a frame having a passenger cabin and a prime mover carried thereon;

wheels for rolling transport of the frame, including a front set of wheels proximate a front end of the automobile and a rear set of wheels proximate an opposing rear end of the automobile, of which one or both sets are composed of steerable wheels and one or both sets are composed of driven wheels;

a suspension system connected between said wheels and the frame to enable relative movement of the wheels upwardly and downwardly of the frame;

a drive system connecting the driven wheels to a shared prime mover;

a steering system carried on said frame and comprising:

a steering wheel in said passenger cabin for driver-controlled steering of said steerable wheels during a normal road travel mode of the automobile; and

for each of said steerable wheels, a respective steering knuckle on which said steerable wheel is rotatably supported, said steering knuckle being swivelable about a respective upright steering axis and coupled to the frame by said suspension system for relative movement upwardly and downwardly thereof;

wherein said steering system is configured to rotate the respective steering knuckle of each steerable wheel through a ninety degree range between a straight-ahead position, in which a rotational axis of the steerable wheel is perpendicularly transverse in plan view to a longitudinal midplane of the automobile to enable longitudinally straight travel of the automobile in said normal road travel mode, and a ninety-degree position, in which the rotational axis of the steerable wheel is parallel in plan view to said longitudinal midplane to enable lateral travel of the automobile in another mode.

### BRIEF DESCRIPTION OF THE DRAWINGS

One embodiment of the invention will now be described in conjunction with the accompanying drawings in which:

FIG. 1A is a schematic bottom plan view of a conventional automobile with conventional two-wheel steering, and shows the steerable front wheels of the automobile in a straight-ahead position.

FIG. 1B is a schematic bottom plan view automobile of FIG. 1A, but with the wheels at their maximum turning limit in one direction, which is less than 90 degrees from the straight-ahead position.

FIG. 1C is a schematic bottom plan view automobile of FIG. 1B, but with the wheels at their maximum turning limit in the other direction, which is once again less than 90 degrees from the straight-ahead position.

FIG. 2A is a schematic bottom plan view of a novel automobile with an increased 90-degree steering range according to the present invention, and shows all four wheels of the automobile in the straight-ahead position.

FIG. 2B is a schematic bottom plan view of the automobile of FIG. 2A, but showing all four wheels in a ninety-degree position for lateral travel of the automobile.

FIG. 3A is a schematic top plan view of the automobile of FIG. 2A.

FIG. 3B is a schematic top plan view of the automobile of FIG. 2B.

FIG. 4A illustrates lateral entrance of the automobile of FIG. 2B into a parallel parking spot using the ninety-degree wheel position.

FIG. 4B illustrates lateral departure of the automobile of FIG. 2B from the parallel parking spot using the ninety-degree wheel position.

### DETAILED DESCRIPTION

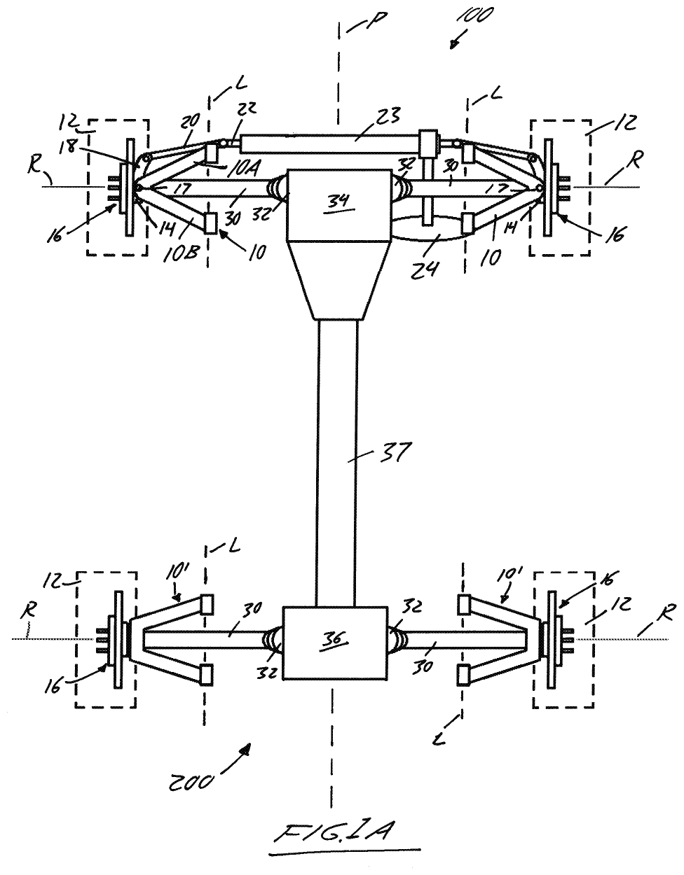

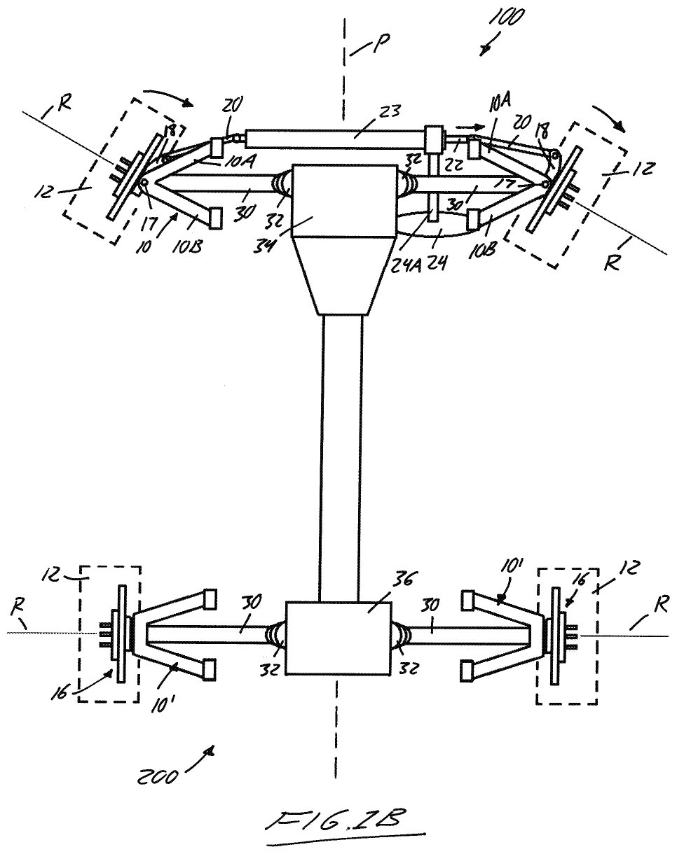

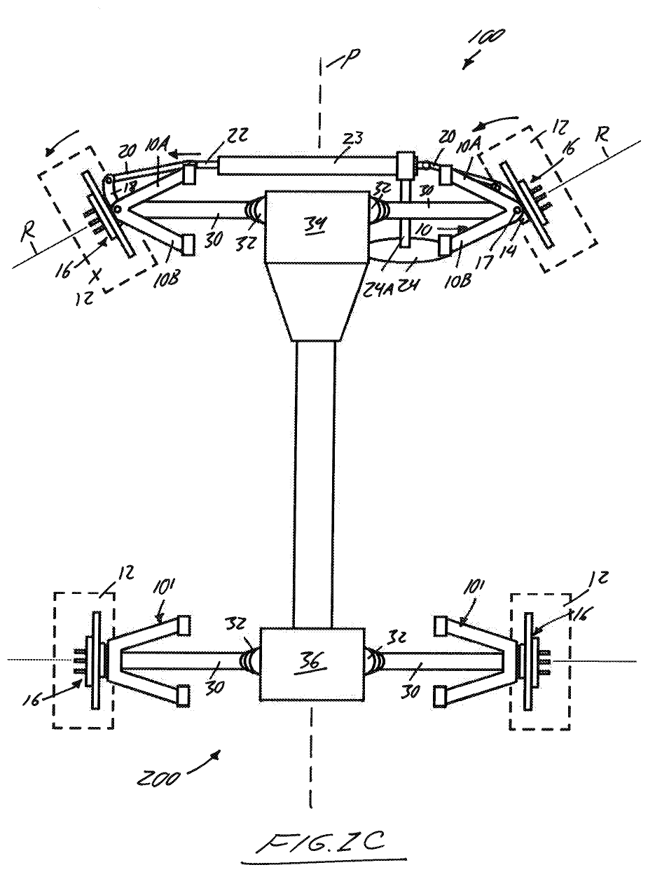

FIG. 1 schematically illustrates select drive components, suspension components and steering components of a conventional automobile with a typical two-wheel steering configuration in which only the two front wheels of the automobile are steerable. A front suspension system of the automobile features control arms 10 for supporting the front wheels 12 of the automobile in upwardly and downwardly movable relation to a frame of the automobile. The illustrated scenario features a Macpherson strut suspension, in which there is only a singular respective control arm 10 for each wheel, though in the instance of a double wishbone suspension, there may be a respective pair of control arms for each wheel (i.e. upper and lower control arms). Each control arm has a generally symmetrical A-shaped structure (hence resembling a “wishbone”) having two legs 10A, 10B that are joined together at an outer end of the control arm furthest from a longitudinal midplane P of the automobile. The two legs 10A, 10B extend in divergent relation to one another toward said midplane P. At an inner end of the control arm nearest to the midplane P, the ends of the two diverging legs are connected to the frame (not shown) of the automobile by respective bushings, about which the control arm can pivot upwardly and downwardly relative to the frame about a longitudinally oriented axis L. At the outer end of the control arm 10, a steering knuckle 14 is coupled thereto by a ball joint. The steering knuckle carries a hub assembly 16 by the respective wheel 12 is rotatably carried on the steering knuckle 14 for rolling movement of the wheel over the ground.

The steering knuckle 14 can swivel about an upright steering axis, which is schematically represented by point 17 at which the lower ball joint connects to the control arm 10 to the steering knuckle. This upright steering axis either (a) intersects both the respective upper and lower ball joints of the two control arms in a double wishbone suspension, or (b) in a Macpherson strut suspension, intersects the singular (lower) ball joint of the singular (lower) control arm and an upper bearing of the suspension strut (not shown) whose bottom end is coupled to the singular control arm. The steering knuckle 14 has a steering arm 18, a free end of which is situated at a radial distance outward from the steering axis, whereby this steering arm 18 can be used to control swiveling movement of the steering knuckle 14 and the attached wheel 12 about the steering axis. For such purpose, a respective tie rod 20 has an outer end thereof coupled to the free end of the steering arm 18, and an inner end coupled to one end of a shared center link 22 of the steering system. The other end of this center link 22 is also connected to a respective tie rod 20 for likewise steering the other wheel on the opposing side of the automobile via connection to the steering arm 18 of that other wheel's steering knuckle 14. In the example of rack and pinion steering, the center link is embodied by a rack that is movable back and forth inside a rack housing 23, and to which the tie rods 20 are connected at their inner ends. The rack is engaged by a pinion in the steering column 24A, whereby rotation of the pinion is actuated via a steering wheel 24 mounted at the opposite end of the steering column inside in the operator cabin of the automobile. In another known type of steering linkage, rather than using a rack and pinion configuration, the center link 22 may alternatively be displaced back and forth by a pitman arm operated via the steering wheel 24.

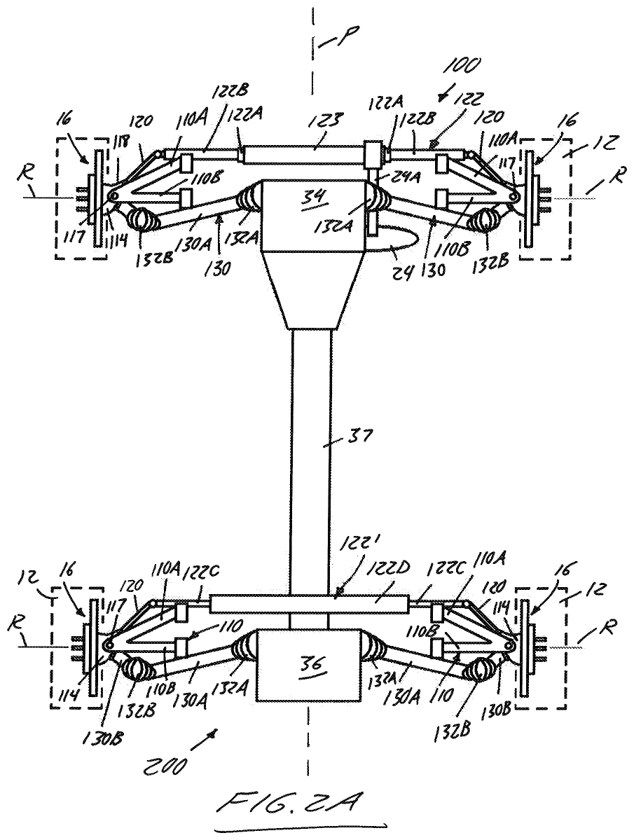

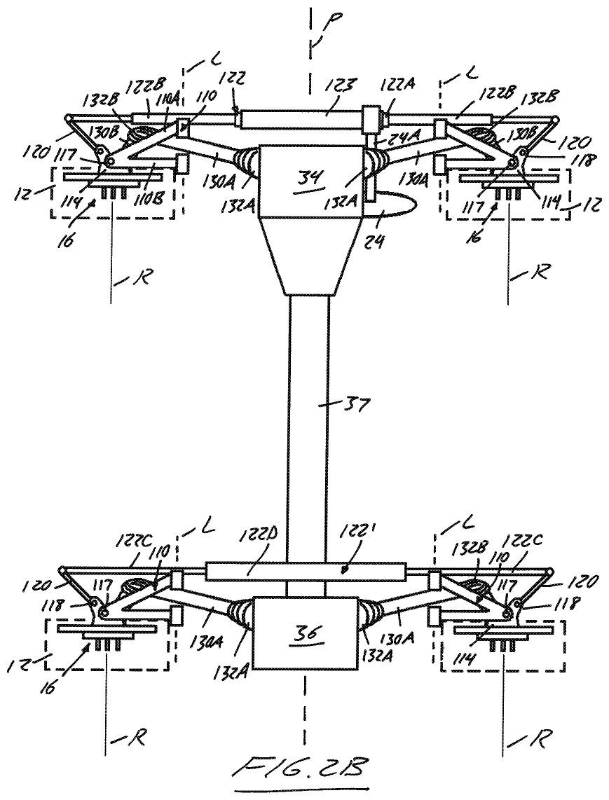

Regardless of the type of steering linkage employed, turning of the steering wheel 24 in opposite directions displaces the center link 22 back and forth in its laterally-spanning direction of perpendicularly transverse relation to the longitudinal midplane P of the automobile. Referring to FIG. 1B, displacement of the center link 22 in a first direction from a default centered position thus pushes the steering arm 18 of one wheel outwardly away from the midplane P, while synchronously pulling the steering arm 18 of the other wheel inwardly toward the midplane P, thus swivelling the two wheels in a same first direction about their steering axes in order to steer the automobile that direction. Referring to FIG. 2B, displacement of the center link 22 in an opposing second direction from the default centered position pushes and pulls on the two steering arms in the reverse fashion, thus swivelling the two wheels and steering the automobile in an opposite second direction.

When the wheels are in a straight-ahead position (FIG. 1A), their rotational axes (in plan view) lie perpendicularly transverse of the longitudinal midplane P of the automobile, whereby rotation of the steerable wheels in a forward direction will convey the automobile longitudinally forward in linear fashion (i.e. “straight ahead”). In the conventional steering setup of FIG. 1, the range through which each wheel can be swiveled about its steering axis from its straight-ahead position is limited to an acutely oblique angle whose value notably lesser than 90-degrees, for example measuring somewhere between 25-degrees and 40-degrees in each direction. As shown, the A-frame shape of the conventional control arm 10 is symmetric in plan view across the rotational axis R of the respective wheel when in the straight-ahead position, and so each leg 10A, 10B of the control arm 10 extends inwardly toward the midplane P of the automobile in oblique relation to the wheel's rotation axis R on a respective side thereof. Thus, even if other mechanical constraints on the wheel's steering range were omitted, the wheel would be blocked from being turned a full ninety-degrees from its straight-ahead position by impact with a respective side of the symmetrically shaped control arm 10.

In a two-wheel drive, all-wheel drive or four-wheel drive automobile, the two steerable front wheels are also driven wheels. Each driven front wheel is rotatably driven about its respective rotation axis R by a respective driveshaft 30. Each driveshaft 30 has a first multi-directional joint 32 (e.g. constant velocity joint (CV joint), or universal joint (U-joint)) at an input end thereof that is coupled to the transmission 34 of the automobile's drivetrain in order to drive wheel rotation via a shared prime mover (combustion engine, or electric motor) of the automobile. A second multi-directional joint (obstructed from sight in the bottom plan views of FIGS. 1A-1C) at an opposing output end of the driveshaft 30 is connected to the hub assembly 16 in order to drive rotation of the wheel using the output power from the transmission. The illustrated example represents an all-wheel drive or four-wheel drive scenario, where each rear wheel of the automobile is also driven by a respective driveshaft 30 using power derived from the prime mover, but via a rear differential 36 of the drivetrain to which power from the transmission is transferred by a longitudinal shaft 37 of the drivetrain. The two rear driveshafts 30 are each connected to the rear differential 36 and the respective rear wheel via a pair of multi-directional joints 32, just as described for the front wheels to accommodate movement of the wheels relative to the frame. Like the front wheels, the rear wheels are movable upwardly and downwardly on rear suspension control arms 10′, which may be similar to those described above for the front suspension, and thus may be of symmetric A-frame shape across the rotational axes R of their respective wheels.

Most automobiles employ two-wheel steering, where only the front wheels are steerable, and so the knuckles on which the rear wheel hub assemblies in this instances are referred to herein as rear knuckles, not steering knuckles, as they need not swivel about respective steering axes 17. In a rear-wheel drive setup, where the front wheels 12 are steerable but not driven, the two driveshafts 30 of the front wheels are omitted. In a front-wheel drive setup, where the front wheels 12 are steerable and driven, and the rear wheels are not driven, the rear wheel driveshafts are omitted. Most automobiles employ only front wheel steering, though some also provide steering of the rear wheels in a four-wheel steering setup. The teachings of the present invention may be applied to any variation of front wheel, rear wheel, all-wheel or four-wheel drive setup, and regardless of whether only one or both sets of wheels are steerable via the steering wheel.

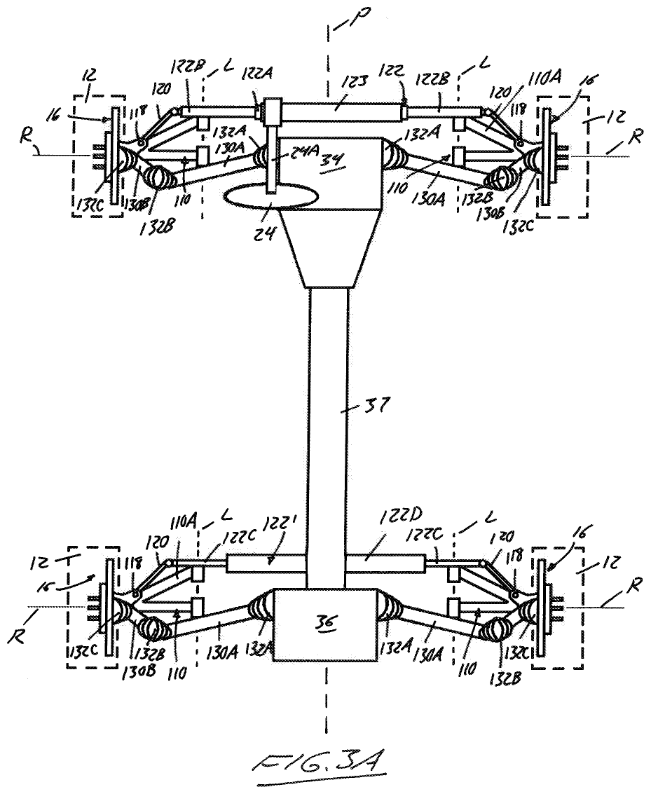

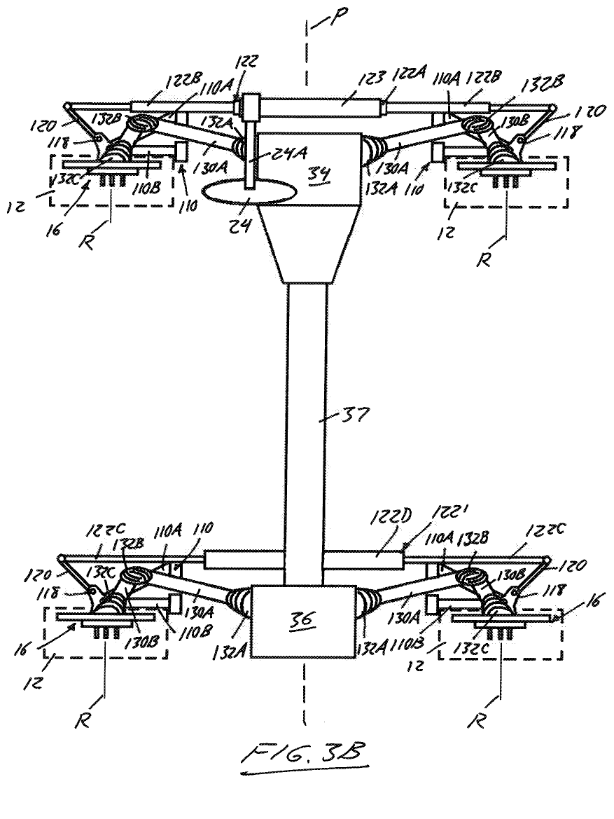

FIG. 2 illustrates an automobile of the present invention with a novel steering system capable of rotating steerable wheels 12 of the automobile through a range of 90-degrees about its steering axis from its straight-ahead position (FIGS. 2A, 3A) to a ninety-degree position (FIGS. 2B, 3B). The illustrated embodiment possesses four steerable wheels 12 capable of this novel 90-degree steering range, whereby both the front wheels and rear wheels can be moved into the ninety-degree position to allow straight lateral rolling movement of the automobile in a linear fashion in the transverse direction perpendicular to the automobile's longitudinal midplane P, thus giving the automobile optimal maneuverability for parallel parking in tight spaces. It will be appreciated however that the same novel 90-degree steering capability imparted to only one of the automobile's two sets of wheels may also be useful for particular automobile manoeuvres, whether for parallel parking or other purpose, and so the invention is not limited specifically to embodiments in which all four wheels are provided with this 90-degree capability, and therefore includes embodiments where only the front wheels, or only the rear wheels, are steerable through the novel ninety degree range.

A longitudinal midplane P of the automobile is once again used as a reference plane, and refers to a vertical plane cutting centrally through the in a longitudinal direction in which front and rear ends 100, 200 of the automobile are spaced apart. FIG. 2 schematically illustrates select drive components, suspension components and steering components of the inventive automobile, other components of which may be of conventional configuration. The front suspension system once again has control arms 110 for supporting the front wheels 12 of the automobile in upwardly and downwardly movable relation to a frame of the automobile about the longitudinal axis L at the bushing-supported inner end of the control arm 110 nearest to the midplane P. However, to accommodate the novel 90-degree steering range of the wheels 12, the control arms 110 differ from the conventional symmetrical shape described above, and instead each possess an asymmetrical shape (in plan view) across the rotational axis R of the respective wheel when said wheel is in the straight-ahead position. A first leg 110A of each control arm once again extends toward the midplane P of the vehicle at an oblique angle (in plan view) to the rotational axis R on one side thereof. The other leg 1108 however resides entirely or substantially on the same side of the rotational axis as the first leg 110A, and lies more parallel to the wheel's rotational axis R (and thus more perpendicular to the midplane P) than the first leg 110A. Additionally, the steering knuckle 114 and the control arm 110 are shaped and configured so that the ball joint connection therebetween, and the resulting steering axis 17, resides outside the wheel 12 on the inner side thereof that faces the midplane P in the wheel's straight-head position, whereas in the conventional example of FIG. 1, the steering axis resides inside the wheel.

As shown in FIGS. 2B and 3B, the asymmetric shape of the control arm 110 and relocation of the steering axis 17 allows the respective wheel 12 to be swung about this relocated steering axis into a ninety-degree position in which its rotational axis R is parallel (in plan view) to the longitudinal midplane P of the automobile, without interference by the control arm 110. Though the illustrated example of the asymmetric control arm 110 has the rear leg 110B being the one that's more perpendicular to the midplane , and thus being the one of the two which is closely neighbored by the wheel 12 when in the ninety degree position, it will be appreciated that this need not necessarily be the case. The asymmetric control arm 110 could be reversed to make its front leg 110A the one that's more perpendicular to the midplane P, and the steering components reconfigured to move the wheel 12 to the front side of the asymmetric control arm 110, rather than the rear side thereof, when in the ninety degree position.

To move the steering knuckle 114 of each front wheel 12 through its novel 90-degree swivel range, the conventional steering linkage described above for FIG. 1 is also modified. Instead of a center link 22 of fixed length that has only one mode of operation (i.e. shifting back and forth based on steering wheel input to steer the vehicle during rolling movement thereof), the center link 122 is an expandable/collapsible link that is normally locked at a static length for this same conventional steering purposes, but can also be selectively unlocked and expanded in length, when the automobile is at a stop, in order to move both front wheels into their ninety degree positions. FIGS. 2A and 3A show the central link 122 in its normal, fully collapsed state of minimum length, during which the steering wheel 24 is usable in its usual fashion to control steering of the automobile by way of a pair of outer steering links 120 (e.g. tie rods) that extend from the opposing ends of the central link 122 to the steering arms 118 on the steering knuckles 114 of the two front wheels 12. The steering wheel 24 thus operates in the same manner as described above for the conventional steering setup of FIG. 1 when the length of the center link 122 is locked, which is therefore referred to as a normal road-travel mode of the automobile. Here, the vehicle travels longitudinally, and more particularly in parallel relation to its longitudinal midplane when the wheels are in their straight-ahead positions. The maximum steering angle to which each steerable wheel can be swiveled about its steering axis from the straight ahead position is limited in either direction in this length-locked state of the center link and corresponding road-travel mode of the automobile's operation, for example being limited in each direction to a value not exceeding 50-degrees.

However, as shown in FIGS. 2B and 3B, when the center link 122 is expanded in length, the outer steering links 120 swivel the steering knuckles 114 of the front wheels about their steering axes 117 into their novel ninety-degree positions. In the illustrated embodiment of the present invention, where both the front set of wheels and the rear set of wheels are movable through a ninety-degree range between the straight-ahead positions and the ninety degree positions, the rear suspension control arms 110 are likewise of the same or similar asymmetrical configuration described above for the front suspension, and the non-steerable rear knuckles 14 of the conventional two-wheel steering system of FIGS. 1A-1C are replaced with steering knuckles 114 of the same or similar configuration used for the front wheels. Accordingly, the rear wheels can likewise each be swiveled through a ninety degree range from the straight-ahead position about an upright steering axis 117 positioned outside the wheel at the inner side thereof where the control arm 110 and steering knuckle 114 connect. To control movement of the rear wheels between the straight-ahead and ninety-degree positions, a rear steering mechanism similar to the modified front steering mechanism is used. The rear steering mechanism thus has a collapsible/expandable center link 122′ whose opposing ends are respectively connected to the steering knuckles 114 of the rear wheels by a respective pair of outer steering links 120 (e.g. tie ends). However, the rear steering center link 122′ differs from the front steering center link 122, with one particular difference in the illustrated embodiment being a lack of rack and pinion or pitman arm connection to the steering column 24A. Though in this illustrated embodiment, the rear wheels are not used for any degree of steering during normal road travel, other embodiments may include means for shifting the expandable/collapsible center link back and forth for such four-wheel steering purposes during normal road travel, for example using known four-wheel steering configurations.

The expansion and collapse of the front and rear center links 122, 122′ may be achieved hydraulically, or by other means of actuation. For example, the front center link 122 may feature a rigid central portion 122A of fixed length, with a pair of hydraulic actuators 122B affixed to opposite ends of the rigid central portion for selective and equal extension to equally expand the center link from opposite ends of the rigid central portion. In the case of a rack and pinion front steering setup, the rigid central portion of the center link embodies the rack that is displaced back and forth inside the outer rack housing 123 by the pinion of the steering column 24A. In the case of a pitman front steering setup, the rigid central portion may instead be an unhoused central bar that is displaced back and forth by the pitman arm. The rear steering setup lacks a need for a pinion-displaced or pitman-displaced central portion, and thus may instead employ a double-ended hydraulic actuator to define the expandable/collapsible center link 122, where the two piston rods 122C of the double-ended cylinder are extendable/retractable from opposing ends of the actuator housing 122D, and are respectively connected to the two outer steering links 120 (e.g. tie rods) of the rear steering mechanism. In other embodiments, alternate means of actuation for either expandable/collapsible center link may include replacement of the hydraulic cylinders with slidable link segments connected to winch-operated cables for pulling thereof in two opposing directions corresponding respectively to expansion and collapse of the center link.

While in the illustrated embodiment the expandable/collapsible front center link 122 for use in the parallel parking mode is incorporated into the same front steering mechanism used in the normal road-travel mode, other embodiments may have the expandable/collapsible front center link 122 and connected outer steering links 120 installed separately as an auxiliary steering mechanism specifically used only in parallel-parking mode, while relying on a more conventional primary front steering mechanism and its associated tie rods for use in normal road-travel mode, provided that a make/break connection is provided somewhere between the center link of the primary front steering mechanism and the front steering knuckles 114 to allow the auxiliary steering mechanism to take over and push the wheels into their ninety-degree positions beyond the normal angular range of the primary steering mechanism, only once the primary steering mechanism has been disconnected from the steering knuckles to allow the larger 90-degree range of rotation.

In the prior art of FIG. 1, the respective driveshaft 30 for each driven wheel is a single-section driveshaft embodied by a singular shaft whose two ends are connected to the wheel 12 and drivetrain (e.g. transmission 34 or differential 36) by a respective pair of multi-directional joints 32. However, this conventional single-section driveshaft setup may not be capable of the necessary angular range to maintain driveable connection to a driven wheel in both the straight-ahead position and novel ninety-degree position. Accordingly, the inventive automobile shown in FIGS. 2 and 3 replaces the conventional single-section driveshaft 30 of each wheel 12 with a multi-section driveshaft 130 that has an input shaft section 130A, an output shaft section 130B and three multi-directional joints 132A, 132B, 132C (e.g. CV joints or U-joints). The input shaft section 130A has an input end thereof connected to the drivetrain (e.g. at transmission 34 or rear differential 36) by multi-directional input joint 132A, and an opposing output end connected to an input end of the output shaft section 130B by multi-directional intermediary joint 132B. An output end of the output shaft section 1306 is connected to the wheel hub of the respective wheel 12 by multi-directional output joint 132C. The division of the driveshaft 130 into two discrete shaft sections 130A, 1306 that are interconnected by the multi-directional intermediary joint 1326 adds the extra angular range needed to maintain driveable connection to the driven wheel in the driven wheel's ninety-degree position. While the illustrated embodiment reflects an all-wheel drive or four-wheel drive automobile where both the front and rear wheels are driven by respective multi-section driveshafts 130, it will be appreciated that in two-wheel drive embodiments, whether front-wheel drive or rear-wheel drive, two of the four illustrated multi-section driveshafts will be omitted.

Since the two wheels of each axle (i.e. the two front wheels, or the two rear wheels) are swiveled in opposite directions into their ninety degree positions, the transmission 32 of the automobile has an additional “parking” gear selection on top of the normal “drive” and “reverse” gear selections, and this parking gear selection has a means for driving the two wheels of the same axle in opposite directions to one another to cause the lateral drive of the vehicle in the parallel parking mode. Even absent such a transmission, the novel steering system still enables lateral movement of the automobile, for example by manual pushing of the automobile in the desired lateral direction form the opposing side of the automobile. Lateral rolling of the vehicle is thus enabled whether powered by on-board means, or outside motive force.

It will be appreciated that the geometry of components shown in the drawings is not intended to be limiting. For example, while the steering arms 118 and outer steering links 120 are shown lying at approximately 45-degrees to the rotational axes R of the wheels 12 in plan view, this angle may vary for one or both steering mechanisms, and for example may be generally parallel to the rotational axes R of the wheels so that the outer steering links 120 lie generally parallel to the rotational axes R of the wheels, for example lying parallel to the center link in the straight-ahead wheel positions and perpendicular to the center link in the ninety-degree positions. If necessary, to accommodate sufficient degrees of freedom in movement of the steering links of either ninety-degree steering mechanism between the straight-ahead and ninety-degree wheel positions, the center link may have a center fulcrum (schematically shown at 150) about which it can horizontally swivel about an upright axis.

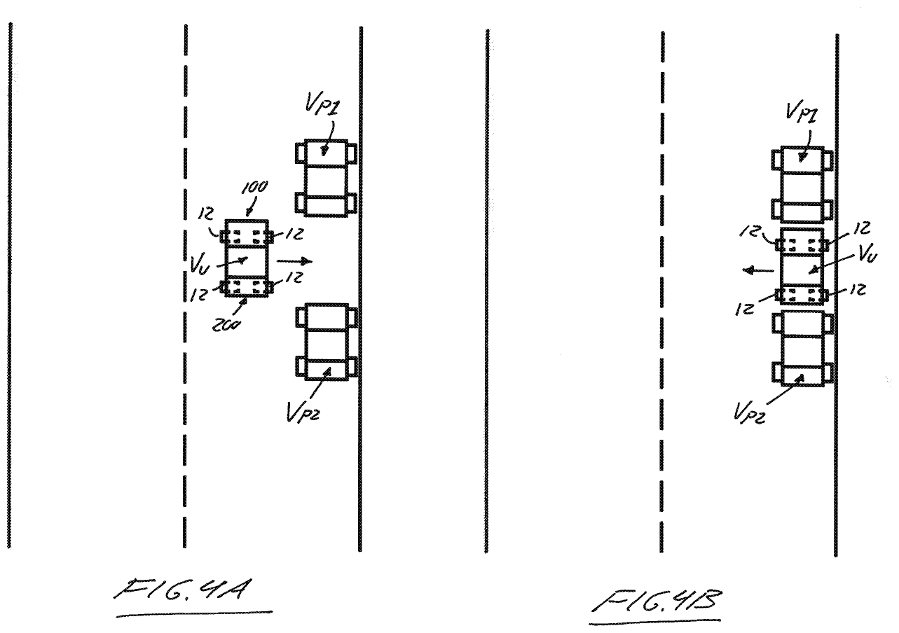

FIG. 4A illustrates a parallel parking situation in which two parked vehicles V_{P1} and V_{P2} are parallel parked at the side of a road, and an open space between the two vehicles is large enough to fit a user vehicle V_{U} equipped with the four-wheel ninety-degree steering capabilities of the illustrated embodiment of the present invention, but is not large enough to enable the use to enter the spot using conventional parallel parking techniques. So instead, once having navigated down the street in the normal road-travel mode of the automobile, the user stops their vehicle directly beside the open parking space SP in alignment therewith so that no part of the user vehicle V_{U} projects past the front or rear end of the parking space. With the user vehicle at a full stop, the expandable/collapsible center links 122, 122′ of the front and rear ninety-degree steering mechanisms are extended to swivel all four wheels about their steering axes into the ninety-degree position, whereupon the user vehicle is horizontally rolled into the parking space in a lateral direction that is perpendicular to the vehicle's longitudinal midplane of the vehicle, and perpendicular to the road's travel direction.

Later on, when departure from the parking space is desired, if sufficient space has since opened up due to the departure or repositioning of one or both of the two vehicles VP1, VP2 previously parked in close proximity to the user vehicle V_{U}, the extendable/collapsible center steering links can be collapsed while still in the parking space to return the wheels to their straight-ahead positions to allow the user to drive forwardly or rearwardly from the parking space in conventional fashion in the vehicle's normal road-travel mode. Alternatively, referring to FIG. 4B, with the wheels still in their ninety-degree positions, the user can once again drive the vehicle laterally out of the parking space in the opposite direction to that which was previously used to park the vehicle, thus laterally relocating the vehicle out of the parking spot back into the adjacent open travel lane of the roadway. Here, with the vehicle at a full stop, the extendable/collapsible center steering links are then collapsed to return the wheels to their straight-ahead positions to allow the user to drive forwardly down the street in normal road-travel mode. It will be appreciated that this parallel parking scenario is presented merely as on non-limiting example of where the ninety-degree capability of one or both sets of the automobile's wheels may be of beneficial use, and is therefore not limiting on the scope of the claimed invention.

Since various modifications can be made in my invention as herein above described, and many apparently widely different embodiments of same made, it is intended that all matter contained in the accompanying specification shall be interpreted as illustrative only and not in a limiting sense.

1. An automobile comprising:
a frame having a passenger cabin and a prime mover carried thereon;
wheels for rolling transport of the frame, including a front set of wheels proximate a front end of the automobile and a rear set of wheels proximate an opposing rear end of the automobile, of which one or both sets are composed of steerable wheels and one or both sets are composed of driven wheels;
a suspension system connected between said wheels and the frame to enable relative movement of the wheels upwardly and downwardly of the frame;
a drive system connecting the driven wheels to a shared prime mover;
a steering system carried on said frame and comprising:
a steering wheel in said passenger cabin for driver-controlled steering of said steerable wheels during a normal road travel mode of the automobile; and
for each of said steerable wheels, a respective steering knuckle on which said steerable wheel is rotatably supported, said steering knuckle being swivelable about a respective upright steering axis and coupled to the frame by said suspension system for relative movement upwardly and downwardly thereof;
wherein said steering system is configured to rotate the respective steering knuckle of each steerable wheel through a ninety degree range between a straight-ahead position, in which a rotational axis of the steerable wheel is perpendicularly transverse in plan view to a longitudinal midplane of the automobile to enable longitudinally straight travel of the automobile in said normal road travel mode, and a ninety-degree position, in which the rotational axis of the steerable wheel is parallel in plan view to said longitudinal axis to enable lateral travel of the automobile in another.

2. The automobile of claim 1 wherein the suspension system comprises, for each steerable wheel, a respective asymmetrical control arm of which, when the steerable wheel is in the straight-ahead position, one side of the asymmetrical control arm spans from the respective steering axis toward the longitudinal midplane of the automobile at an oblique angle to the rotational axis of the steerable wheel on one side of said rotational axis, and a second side of the asymmetrical control arm spans from the respective steering axis toward the longitudinal midplane in a more parallel relation to the rotational axis of the steerable wheel on the same side thereof, whereby the second side of the asymmetrical control arm accommodates swiveling of the steering knuckle and steerable wheel into the ninety-degree position.

3. The automobile of claim 1 wherein the steering system further comprises, for each steerable wheel, a respective outer steering link having one end coupled the respective steering knuckle and another end pivotally coupled to a respective end of a central steering link that is expandable and collapsible between a collapsed state that corresponds to the straight-ahead position of the steerable wheel, and an expanded state that corresponds to the ninety-degree position of the steerable wheel.

4. The automobile of claim 1 wherein the drive system comprises, for each wheel that is both a driven and steerable wheel, a respective multi-section driveshaft comprising an input section rotatably driven by the prime mover, and output section connected to said driven and steerable wheel via a multi-directional output joint, and a multi-directional intermediate joint connecting said input and output sections of the multi-section driveshaft, wherein a combined angular range of said multi-directional joints is sufficient to allow the ninety-degree range of movement of the driven and steerable wheel between the straight-ahead and ninety-degree positions without disconnection of the multi-section driveshaft from said driven and steerable wheel.
